(19) United States
(12) Patent Application Publication
(10) Pub. No.: US 2024/0200403 A1
(43) Pub. Date: Jun. 20, 2024

(54) ROLLUP DOOR TENSION DEVICE

(71) Applicant: SNL STEEL LLC, Lake Success, NY (US)

(72) Inventors: Michael HUMPHREY, Putnam Valley, NY (US); Dylan PETTIT, Wappingers Falls, NY (US); Mike STANICK, Manorville, NY (US); John BUTTERICK, Pleasantville, NY (US)

(21) Appl. No.: 18/068,635

(22) Filed: Dec. 20, 2022

(51) Int. Cl. E06B 9/60; E06B 9/17

(52) U.S. Cl. CPC E06B 9/60; E06B 9/17

(57) ABSTRACT

The torsion spring is disposed around an axle/shaft and fixed to the axle/shaft at one end, such that the torsion spring rotates with the door drum and fixed to a spring plate as a stationary structure at the other end. The spring plate does not rotate while the torsion spring rotates. The torsional forces created in the spring by the rotation of the door drum provides a variable torque which counteracts the weight of the flexible door. As the flexible door is lowered, the torsional forces developed in the spring pull in the opposite direction of the travel of the flexible door. The amount of tension resulting from the torsional forces generated in the torsion spring determines the performance characteristics of the flexible door.

### BACKGROUND

### 1. Field of Invention

The present invention relates generally to a door winding device and more specifically to an apparatus for adjusting the tension of a torsion spring in the door winding device for the rollup doors.

### 2. Background of the Art

A rollup door is a curtain, or the like door made of a flexible material that raises and lowers by means of a rotating axle located above the door frame. A flexible door is conventionally attached at an upend to door drums that rotate with the axle/shaft. As the axle/shaft rotates, the door rolls up onto the axle/shaft. If the direction of rotation of the axle/shaft is reversed, the flexible door rolls down off the axle/shaft and travels downward to close. Many such rollup doors employ a coil spring, and the coil spring is usually installed at the top of the door to counterbalance the weight of the door. In some rollup doors, a spring is loaded with a certain amount of tension that applies a torque to the axle/shaft that tends to rotate the axle/shaft in a direction that would move the rollup door upwards to counterbalance the weight of the door. The amount of weight on the rollup door varies as it moves downward and more and more of the rollup door is in a vertical position. If there is too little tension, the weight of the door may cause the door to drift down from the open position to the closed position. If the tension is too great, the door may be hard to pull down and it may not stay closed. If the amount of tension is set correctly, the door can be lowered gently, and a balance will be struck between the weight of the door and the force exerted by the spring. A spring tensioning mechanism is required to provide the correct amount of tension to a coil spring.

### SUMMARY

The present invention is a door package assembly (500) containing a spring tensioning mechanism that includes a door drum (110), a spring plate (150), an axle/shaft (190) passing through the torsion spring (130), and a sheet metal tube (160). The flexible door (5) is wound up around the sheet metal tube (160). The sheet metal tube (160) encloses the torsion spring (130) and the spring plate (150). The door drum (110) is attached to the one end of the torsion spring (130) and freely rotates about the axle/shaft (190). The spring plate (150) is attached to the other end of the torsion spring (130) in the sheet metal tube (160) and is attached to the axle/shaft (190). As the tube (160) rotates, the flexible door (5) rolls up or down onto the tube (160). The spring plate (150) is positioned in the tube (160) and welded to axle/shaft (190), so the spring plate (150) does not rotate while the door drum (110) rotates with the tube (160), that is, the axel/shaft (190) remains fixed during normal opening and closing of the rollup door. The spring plate (150) which is welded to axle/shaft (190) is attached to the torsion spring (130) using, for example, a bolt (140) and the spring plate (150) does not rotate along with the door drum (110). The torsion spring (130) is usually disposed around an axle/shaft (190), such that a first end of the torsion spring (130) rotates with the door drum (110) and a second end is fixed to the spring plate (150) as a stationary structure at the other end. The spring plate (150) does not rotate while the first end of the torsion spring (130) rotates. The torsional forces created in the spring by the rotation of the door drum (110) provide a variable torque which counteracts the weight of the flexible door (5). As the flexible door (5) is lowered, the torsional forces developed in the torsion spring (130) pull in the opposite direction of the travel of the flexible door (5). The amount of tension resulting from the torsional forces generated in the torsion spring (130) will determine the performance characteristics of the flexible door (5). The sufficient tension of the torsion spring (130) would be required to make a counterbalance, such that the flexible door (5) would fully close and only a small amount of force would be necessary to raise the door from the closed position. If the torsion spring (130) is required to adjust an optimal position, the installer would rotate an assembled tension device (50) positioned at a bracket (70R) using a wrench or socket wrench. After which, an installer would repeat the pre-tensioning procedure to charge the torsion spring (130).

### BRIEF DESCRIPTION OF THE DRAWINGS

Various embodiments are described below with reference to the drawings wherein:

FIG. 1 is a perspective front view of a flexible door rolling down and a door package with a sheet metal tube cover according to embodiment of the present disclosure;

FIG. 2 is a perspective front view of a flexible door inside view of the flexible door exposing each side of the flexible door package assembly without a sheet metal tube cover according to embodiment of the present disclosure;

FIG. 3 is a perspective side elevational view of the flexible door with vertical guides according to embodiment of the present disclosure;

FIG. 4-5 is a perspective side elevational view of a door package assembly with vertical guides with a bracket to secure on the wall according to embodiment of the present disclosure;

FIG. 6 is an exploded perspective view of the door package assembly with the sheet metal tube (160) on top of the flexible door;

FIG. 7 is a section view of the door package assembly with a bracket and a torsion spring between a door drum and a spring plate according to the present disclosure;

FIG. 8 is an enlarged exploded perspective front view of the tension device; and

FIG. 9 is an isometric view of the tension device depicting further details with teeth with a tension device plate, a ring-shaped latch hook, a bar with square hexagonal bolt, and a bracket in a sold line according to embodiment of the present disclosure.

Like reference numerals indicate similar parts throughout the figures.

### DESCRIPTION OF THE PREFERRED EMBODIMENTS

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

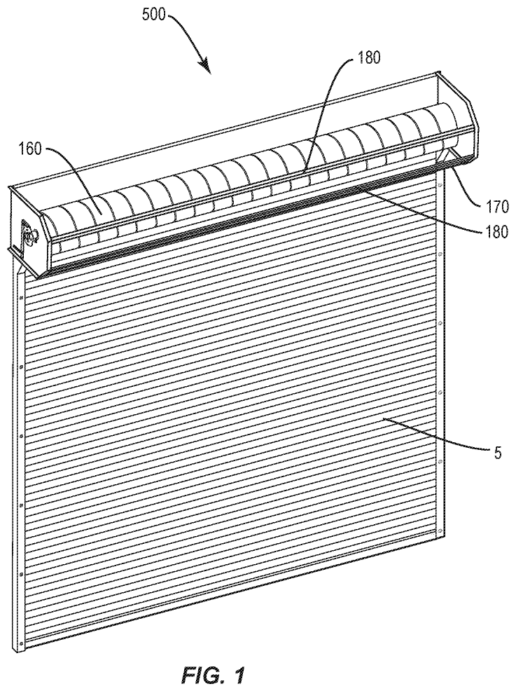

As shown in FIGS. 1-9, the curtain like door delivers a tension to the torsion spring (130). The flexible door (5) is typically attached on the tube (160) that rotates with the door drum (110). The top edge of the flexible door (5) can be attached on the sheet metal tube (160). The flexible door (5) will wrap around the perimeter of the tube (160) if the door drum (110) is rotated in one direction and will unwrap from the perimeter of the sheet metal tube (160) and if the door drum (110) is rotated in the opposite direction. Because of the effect of gravity on the door, the weight of door will tend to draw the door downward and unwrap the door from the sheet metal tube (160). FIG. 1 is a front view of the flexible door (5) rolling down and a door package assembly (500) with the sheet metal tube cover (160), the upper box angle (170), the lower box angle (180). In another embodiment, 1 of 4 the upper/lower 45° angels (170), (180) can be eliminated or relocated. The tube (160) will be made using a pre fab flat metal sheet formed into a tube; other tubes may be contemplated.

Each part in the door package assembly

Parts

| | Description |
|---|---|
| A | Bar with Hexagonal Bolt (10) |
| B | Steel pin (20) |
| C | Cotter pin (30) |
| D | Tension spring (600) |
| E | Tension device plate (50) |
| F | Spring-loaded pin (60) |
| G | Bracket (70R), (71L) |
| H | Bracket and tension device assembled (80) |
| I | Bearing for bracket (90) |
| J | Bearing for door drum (100) |
| K | Door drum (110) |
| L | Spring bolt on drum (120) |
| M | Torsion spring (130) |
| N | Spring bolt on spring plate (140) |
| O | Spring plate (150) |
| P | Tube (160) |
| Q | Upper Box angle (170) |
| R | 45° angle (180) |
| S | Axle/Shaft (190) |
| T | For holding tube to drum (200) |

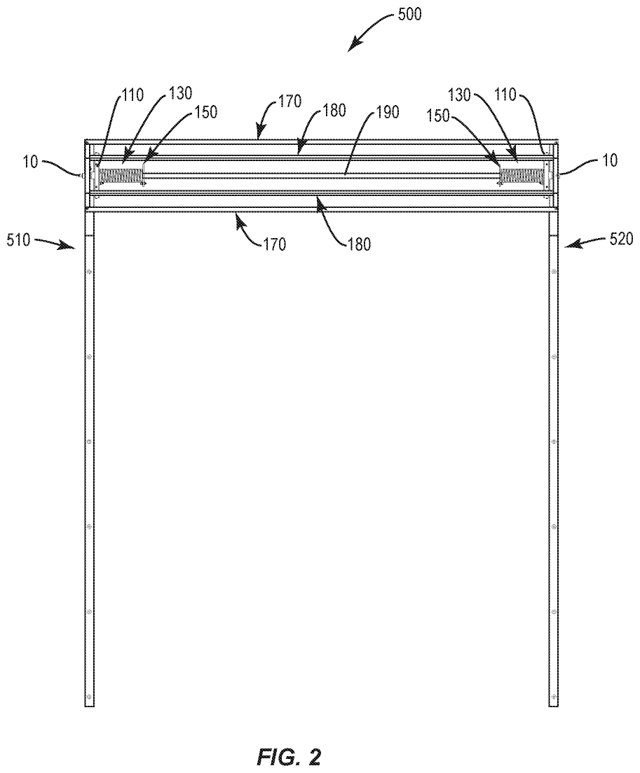

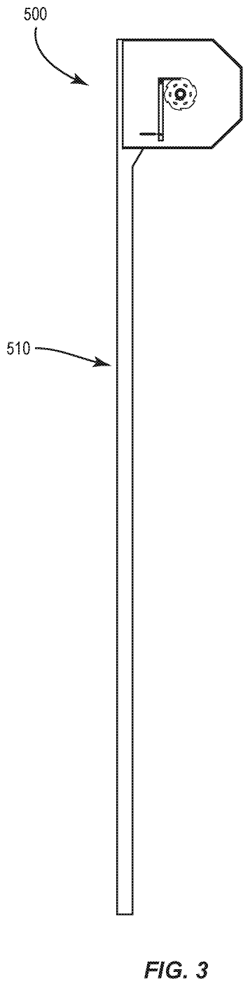

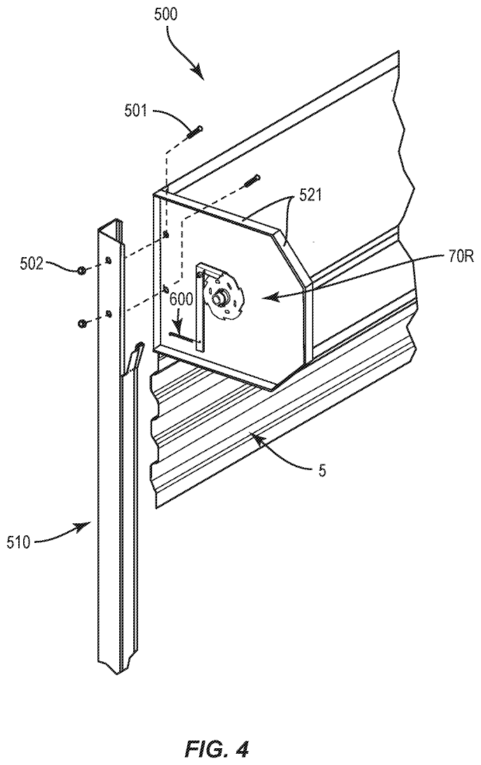

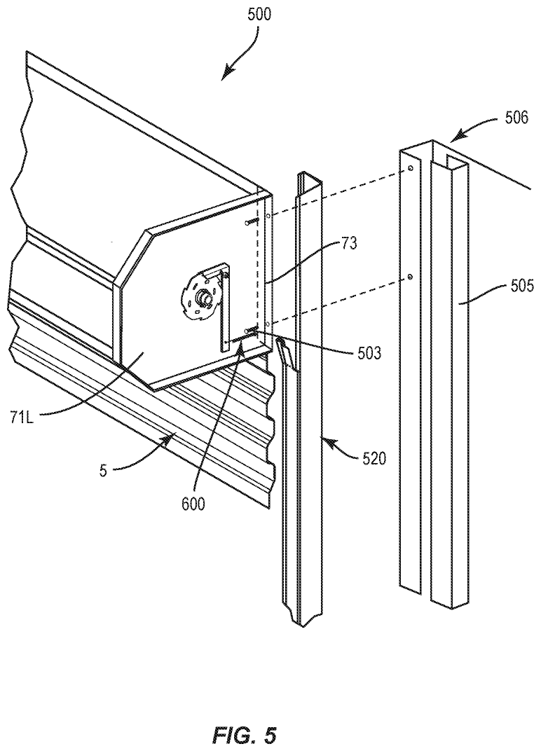

FIG. 3 is a side elevational view of the flexible door with vertical guide (510). A flexible door frames includes a first vertical guide (510) at a first end thereof and a second vertical guide (520) at a second end thereof. The door package assembly (500) is mounted on the top of the flexible door frame, and the door package assembly (500) can be assembled with two vertical guides (510) and (520) as seen in FIG. 2. Referring to FIG. 4, the bracket (70R) is allocated to the end of the door package assembly (500) as the part of the door package assembly (500). The one side of the door package assembly (500) is attached to the first vertical guide (510). The other side of the door package assembly (500) is attached to the second vertical guide (520). As shown in FIG. 4, the bracket (70R) of the door package assembly (500) is secured to the first vertical guide (510) using bolts (501). In another embodiment, the vertical guides (510), (520) with a head stop to secure the vertical guides on the wall according to embodiment of the present disclosure, the vertical guides (510), (520) have a head stop at the height about below the door package assembly (500). The head stop works as to secure the vertical guides (510), (520) to the wall. The head stop has a squire with chamfered corners, and the one side of the head stop is opened to embrace vertical guide (510) or (520). The end of the opened side has a little curved into the head stop so the head stop can catch the vertical guides (510) (520). As another embodiment, referring particularly to FIG. 4, the brackets (70R), (71L) can have the flanges (521) bent outward on three sides. The flange (521) on the back side that attaches to the door frame can be bent inward. The front 90-degree corners can be chamfered to 45 degrees. So, the bracket 70R can no longer have an access window cut in it. Referring particularly FIG. 5, the tension devise plate (50) can be optionally moved from the right side to the left side of the door package assembly (500). The bracket (71L) of the door package assembly (500) is secured to the second vertical guide (520) using bolts (503). The backing plates (505) can be replaced by a U-channel placed in the door frame (506).

Referring to FIG. 2, the door package assembly (500) is deployed in the flexible door frame. The door package assembly (500) is placed on top of the flexible door frames. The door package assembly (500) can be a box shape, or any variation shapes and the door package assembly (500) retain the brackets (70R) (71L), the bracket (71L), the axle/shaft (190), the tube (160), the torsion spring (130) and the door drum (110). The bracket (70R) is located the one end of the door package assembly (500) and the bracket (71L) is located the other end of the door package assembly (500). In other embodiment, the axle/shaft (190) is passing through the torsion spring (130) and the tube (160) and is welded to the spring plate (150). The placement of where the axle/shaft (190) penetrates in the brackets (70R), (71L) may need to slightly offset from the center of the brackets.

Referring particularly to FIG. 2, the torsion spring (130), the door drum (110), and the spring plate (150) are installed at each side, right and left, of the door package assembly (500). Each end of the door package assembly (500) has the torsion spring (130), the door drum (110), and the spring plate (150) for similar functions but is not required for operation of the system. The flexible door (5) can be lowered gently, and the flexible door's balance will be retained.

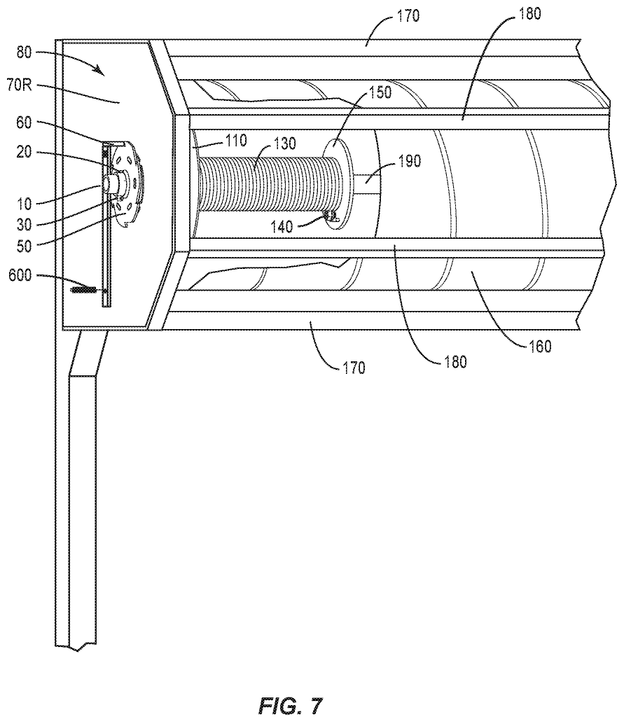

FIG. 7 is the enlarged exploded perspective inside partial view of the door package assembly with the bracket (70R), the torsion spring (130), and the remaining door parts. The tube (160) covers the spring plate (150) and the torsion spring (130). The flexible door (5) is wound up around the tube (160) and can be contained into the door package assembly (500). The bracket (70R) and tension device assembled (80) locks the axle/shaft (190) in the fixed position. As the door drum (110) rotates, the flexible door (5) rolls up onto the tube (160). If the direction of rotation of the door drum (110) is reversed, the door rolls down from the tube (160) and travels downward to close. The axel/shaft (190) remains in a fixed position during normal opening and closing of the rollup door (5).

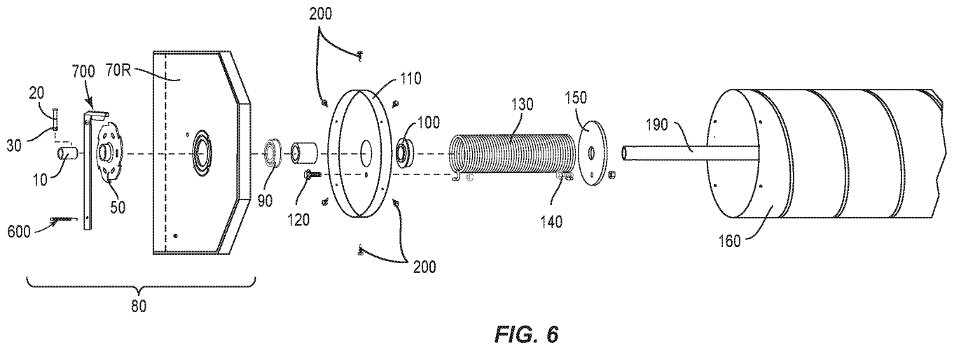

Referring to FIG. 6, the spring plate (150) is slid into the tube (160) and welded to axle/shaft (190), so the spring plate (150) does not rotate while the door drum (110) rotates with the tube (160). The torsion spring (130) is attached to the spring plate (150) using a bolt (140) on the torsion spring (130). The bolt (140) is tightened to secure the torsion spring (130) in place attached to the spring plate (150) on the one end. The torsion spring (130) is attached to the door drum (110) on the other end, which is not connected to the spring plate (150). The torsion spring (130) is also attached to the door drum (110) using a bolt (120). The door drum (110) is slid in the door package assembly (500) and is attached to the tube (160) using rivets (200) so the door drum (110) will rotate as the door moves ups/downs along with the tube (160). In other embodiment, it can use flat head screws or spot welds to attach the tube (160) instead of the rivets (200). Other means to attach the door drum (110) to the tube (160) are contemplated. The rivets (200) are made on the outward end of tube (160) and the door drum (110) for holding the tube (160) to the door drum (110). The bearing for the door drum (100) slides into the door drum (110) around the axle/shaft (190) for clean rotation. The bearing for the bracket (90) slides into the brackets (70R) and the door package assembly (500) assembled around the axle/shaft (190) for clean rotation.

The tension device plate (50) and the bracket (70R) slide together to create the brackets and tension device assembled (80), where the tension device plate (50) is affixed to the axle/shaft (190). The tension devise plate (50) can have six holes in the plate, but the number is not limited thereto, and various modifications can be made in the embodiment. The bar with hexagonal bolt (10) slide inside the axle/shaft (190) and be secured using a steel pin (20) and a cotter pin (30). The bar with hexagonal bolt (10) can be assembled into the center of the tension device plate (50) with the steel pin (20) and the cotter pin (30) as seen in the FIG. 6. The axel/shaft (190) itself can be machined to have an end that can be easily rotated with a wrench to replace the bar (10). In another embodiment, the bar (10) can have a hole at the end instead of a square or hexagonal head. The bolt with a hexagonal head can be placed in the hole and secured via a hole in it with the steel pin part (20).

Referring to FIG. 2, when the flexible door (5) on the tube (160) rolls down, the door drum (110) is rotated in one direction and the torsion spring (130) attached to the door drum (110) is coiled in the same direction. The spring plate (150) attached to the other end of the torsion spring (130) is fixed and it does not rotate. Thereby, the tension in the torsion spring (130) is increased by rotating the door drum (110) in one direction. For example, when the flexible door (5) rolls down as seen in the FIG. 1, the door drum (110) rotates in one direction and the tension in the torsion spring (130) is increased as seen in the FIG. 2. While the door drum (110) rotates by the flexible door (5) rolling down, the tension energy is accumulated into the torsion spring (130). The flexible door (5) can be locked by a latch or hook in a certain height. The flexible door (5) can have a loop or a ring for paddle lock to be locked in a certain position. In another embodiment, the vertical guides (510), (520) may have a latch to lock the flexible door (5) in a certain position. The flexible door (5) having a hook or a ring can be hung up on the vertical guide's latch. The accumulated tension energy in the torsion spring (130) by rotating the door drum (110) in one direction is relieved when the flexible door (5) on the sheet metal tube (160) rolls up. The reverse rotating direction of the door drum (110) makes the torsion spring (130) loosen or uncoiled. Thereby, the tension of the coiled torsion spring (130) is relieved by the reverse direction of the door drum (110). The fixed spring plate (150) is not rotated in either direction but supports the torsion spring to increase or relieve a tension on the fixed position.

Referring to FIG. 7, the bar with hexagonal bolt (10) and the tension device plate (50) will lock in place once the desired tension is reached using the steel pin (20) and the cotter pin (30). The bar with hexagonal bolt (10) is welded to the end plane of the door package assembly (500) and connects to the torsion spring (130) through the bracket (70R). The amount of the torsion pre-loaded in the torsion spring (130) can be increased by rotating a bar with hexagonal bolt (10) of the torsion adjustment mechanism. The torsion spring (130) is pre-loaded with an amount of torsion so as to assist in raising the flexible door (5). The system also includes a torsion adjustment mechanism coupled to the axle/shaft (190) and comprising the hexagonal bolt (10) non-rotatably attached to one end of the torsion spring (130), and the tension device plate (50) non-rotatably attached to either the anchor or the collar. The hexagonal bolt (10) and the tension device plate (50) together form a one-way bearing between the hexagonal bolt (10) and the tension device plate (50), which allows relative rotation between the hexagonal bolt and the tension device plate (50) in one direction, but not in the opposite direction. Accordingly, the tension device plate (50) rotates in one direction. The bar with hexagonal bolt (10) is rotated using a wrench or socket wrench. The torsion spring (130) is coiled with the bar with hexagonal bolt (10) since the torsion spring (130) and the bar with hexagonal bolt (10) are connected. The amount of the torsion pre-loaded in the torsion spring (130) is increased by rotating a bar with hexagonal bolt (10) in one direction.

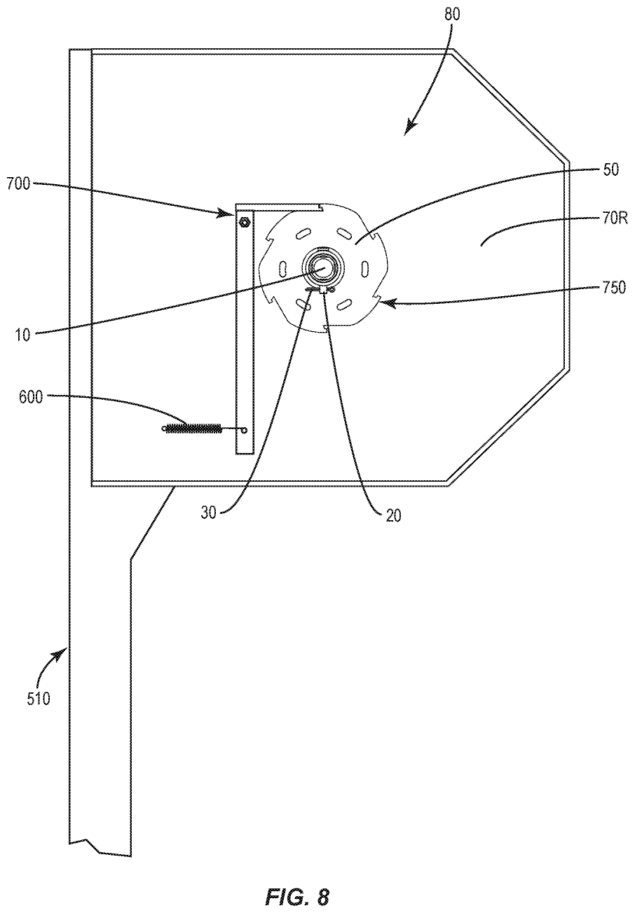

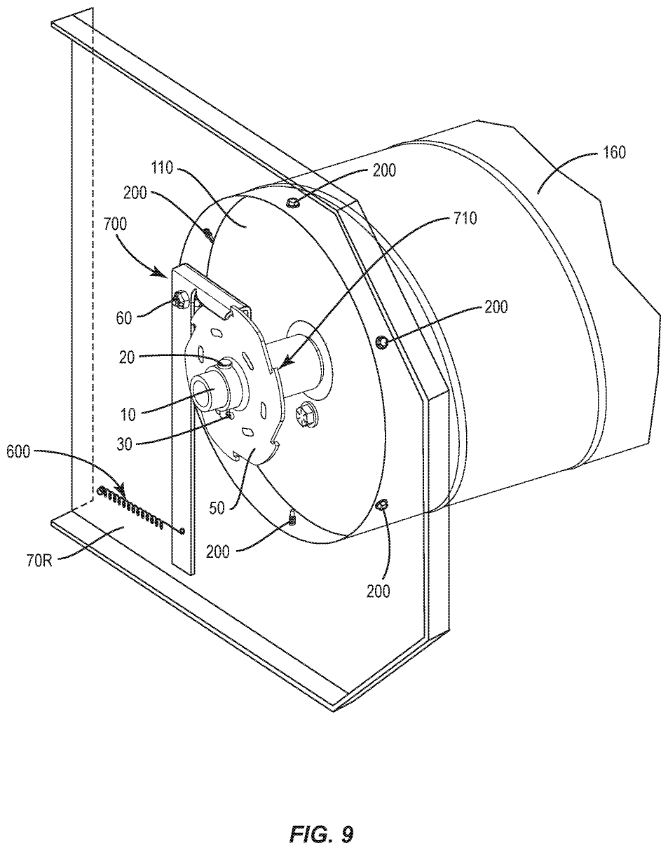

Referring to FIG. 9, the tension device plate (50) gears into the ring-shaped latch (700). The ring-shaped latch (700) is secured to the bracket (70R) with a spring-loaded pin (60). The spring-loaded pin (60) can screw up into the ring-shaped latch (700) into the bracket (70R). The rotation of the bar with hexagonal bolt (10) allows the rotation of the axle/shaft (190) creating tension in the torsion spring (130). Referring particularly to FIG. 8, the bar with hexagonal bolt (10) and the tension device plate (50) will lock in place by a hook of the ring-shaped latch (700) once the desired tension is reached. The tension device plate (50) includes a plurality of radically projection teeth (750) having notches therebetween. A latch is attached to a fixed bracket and engageable with teeth of the ratchet wheel.

Referring particularly to FIG. 8, the tension device assembly (80) can now have a vertical lever in the ring-shaped latch (700) that extends toward the bottom of the bracket (70R). The spring (600) can be attached near the bottom of the lever to provide tension on the plate (50). The other end of the spring (600) will be secured via a tab bent in the bracket. In another embodiment, the ratchet wheel can be covered up with a cover to prevent from any dust or any substances. Teeth are generally triangular in shape and have a lead surface and trailing surface on either side of the tip of teeth (750). Relative to a radially extending line, the leading surface of tooth has a positive slope. In another embodiment, the tooth can be 8 or more toothed sprockets or 6 toothed sprockets. The trailing side of tooth may be parallel to the radial line or be undercut, creating a positive slope relative to the radial line, as shown. The degree of slope on the leading side of tooth is greater than the slope of the trailing side. The teeth may be circumferentially spaced from each other by a land may be arcuate and may lie along the same circle. The ring-shaped latch catches the teeth of the tension device plate and stop the movement of the tension device plate (50). The ring-shaped latch (700) hooks the teeth of the tension device place (50) to prevent reverse rotation. A user can lift up the ring-shaped latch to loosen the amount of the torsion pre-loaded in the torsion spring (130).

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

Where this application has listed the steps of a method or procedure in a specific order, it may be possible, or even expedient in certain circumstances, to change the order in which some steps are performed, and it is intended that the particular steps of the method or procedure claim set forth herein below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A door package assembly for a rollup door, comprising:
an axle;
a spring plate positioned about the axle and attached to the axle;
a spring having a first end and a second end, positioned about the axle, and attached to the spring plate at the first end;
a door drum positioned about the axle and attached to the second end of the spring; and
a tube attached to an outer edge of the door drum.

2. The door package assembly of claim 1, further comprising:
a tension device attached to an end of the axle, the tension device configured to provide a pre-set tension to the spring.

3. The door package assembly of claim 2, wherein the tension device comprises:
a ratchet wheel attached to the end of the axle; and
a latch attached to a fixed bracket and engageable with teeth of the ratchet wheel.

4. The door package assembly of claim 1, further comprising:
wherein the door drum is attached to the one end of the spring and the spring plate is attached to the other end of the spring;
wherein the door drum rotates when the rollup door moves but spring plate does not rotate;
the tube wrapping around the spring and the spring plate and connecting to the door drum; and
the axle passing through the spring and the tube and connected to the spring plate.

5. The door package assembly of claim 4, wherein the spring plate is welded to the axle.

6. The door package assembly of claim 4, wherein a tension in the spring is increased by rotating the door drum in one direction, and the tension in the spring is decreased by rotating the door drum in reverse direction.

7. The door package assembly of claim 6, wherein the door drum is rotated in one direction and the spring attached to the door drum is coiled in the same direction.

8. The door package assembly of claim 4, wherein the spring is disposed around the axle and attached to the door drum and the spring plate using a bolt.

9. The door package assembly of claim 4, wherein the rollup door is wound up around the HVCA tube.

10. The door package assembly of claim 4, wherein a tension device locks the axle in the fixed position.

11. The door package assembly of claim 4, wherein a tension device embraces a bracket and an assembled tension device.

12. The door package assembly of claim 4, wherein rivets are used to attach the door drum to the tube.

13. The door package assembly of claim 4 further comprising a vertical guide as to support the door package assembly on the top of the rollup door.

14. A door package assembly for a rollup door, comprising:
a tension device having a bracket and a tension device plate;
a door drum connecting to the bracket; and
a spring incorporating the door drum and a spring plate, wherein the door drum is attached to the one end of the spring and the spring plate is attached to the other end of the spring, and the spring plate being fixed to the axle.

15. The door package assembly of claim 14, wherein a steel pin and a cotter pin are used to attach the tension device plate into the bracket.

16. A door package assembly for a rollup door, comprising:
a bar with hexagonal bolt welded on the end of the door package assembly;
a tension device plate attached to the bar with hexagonal bolt;
a spring attached to the bar with hexagonal bolt at the end of the spring through the tension device plate; and
a latch gearing into the teeth of the tension device,
wherein the bar with hexagonal bolt and the tension device plate rotates in one direction for a pre-loaded torsion of the spring.

17. The door package assembly of claim 16, wherein the bar with hexagonal bolt locking in place of the spring.

18. The door package assembly of claim 16, wherein the amount of the torsion pre-loaded in the spring is increased by rotating a bar with hexagonal bolt.

19. The door package assembly of claim 16, wherein the bar with hexagonal bolt is rotated using a wrench or socket wrench.

20. The door package assembly of claim 16, wherein the bar with hexagonal bolt rotates in a reverse direction when ring-shaped latch is lifted from the gear.
